(19) United States
(12) Patent Application Publication
(10) Pub. No.: US 2007/0032610 A1
(43) Pub. Date: Feb. 8, 2007

(54) Energy responsive composition and associated method

(75) Inventors: Sergei Kniajanski, Clifton Park, NY (US); Hong Zhong, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/199,466

(22) Filed: Aug. 8, 2005

(51) Int. Cl. C08L 83/04

(52) U.S. Cl. 525/477

(57) ABSTRACT

A composition is provided that may include the product of a first material having a low-temperature fluidity point including a first functional group; and, a second material including a second functional group. The first functional group can interact with the second functional group below a threshold temperature to form a product having a viscosity greater than the viscosity of the first material or of the second material.

### STATEMENT REGARDING FEDERALLY SPONSORED RESEARCH & DEVELOPMENT

This invention was made with Government support under contract number 70NANB2H3034 awarded by National Institute of Standards and Technology. The Government has certain rights in the invention.

### BACKGROUND

The invention includes embodiments that may relate to an energy responsive composition. The invention includes embodiments that may relate to a method of making or using the energy responsive composition.

Self-assembled networks and composite structures may have properties and characteristics that are useful in various applications. Non-covalent interactions may control higher order architecture in self-assembled network and composite structures. The dynamic nature of the non-covalent interactions may permit the structures to be formed reversibly, thus enabling modular construction of supramolecules. An example of a natural system may include protein and/or DNA in which hydrogen bonding between functional groups may build a secondary structure. Synthetic systems have been designed in which complementary functionalities, such as hydrogen bond donor-acceptor pairs or Lewis acid-Lewis base pairs, may associate with each other to form the supramolecular architecture.

The individual chains or components of the natural and synthetic self-assembled systems may be solid at moderate temperatures, and may decompose at or below a fluidity point. The fluidity point is the temperature range at which a material transitions from a solid state to a fluid state (e.g., flows under its own weight). To assemble the supramolecular structure from such components, a solvent may dissolve individual components so that non-covalent interactions may occur on a reasonable time scale. Removal of the solvent may result self-assembly of the supramolecule. But, the use of solvents may be undesirable for reasons such as a requirement for at least one additional processing step, extra energy consumption during processing, and/or potential environmental concerns.

Some self-assemblies may be formed from non-covalent interactions in systems containing polymers with polar backbones. But, the interactions may be too weak to assemble supramolecular structures when polymers with non-polar backbones are involved.

An available siloxane polymer may contain self-complementary hydrogen bonding groups. However, the self-complementary nature of the binding unit may result in intra-chain, as well as inter-chain, associations. Intra-chain associations may limit both the modularity and the selectivity in supramolecular complexation.

It may be desirable to have a system where individual components may reversibly form inter-chain self-assemblies or supramolecules. It may be desirable to have at least one component that has a fluidity point lower than its decomposition temperature. It may be desirable to have self-assembly taking place without a solvent. Furthermore, it may be desirable that the self-assembly occurs within a non-polar polymeric system (between polymeric molecules with non-polar backbone).

### BRIEF DESCRIPTION

In one embodiment, a composition is provided that may include the product of a first material and a second material. The first material may have a low-temperature fluidity point and may include a first functional group. The second material may include a second functional group. The first functional group can interact with the second functional group below a threshold temperature to form a product having a viscosity greater than the viscosity of the first material or of the second material.

In one embodiment, a composition is provided that may include a first oligomeric or polymeric material that may have a low-temperature fluidity point and may include a first functional group; and a second material that is different from the first material. The second material may include a second functional group that is different from the first functional group. The first functional group and the second functional group may form a reversible chemical bond to increase the viscosity of, or solidify, the composition. The first functional group and the second functional group may disassociate from each other in response to input of energy in an amount that is above a threshold energy level. A proviso includes that the reversible chemical bond is not a covalent bond.

In one embodiment, an electronic apparatus is provided that may include a heat-generating unit having a surface; a heat-dissipating unit having a surface; and an energy responsive composition disposed on at least one of the heat-dissipating unit surface or the heat-generating unit surface.

In one embodiment, a rubber article is provided that may include the energy responsive composition. The rubber article may be formed as a tire, in which the energy responsive composition may respond to shear force by reversibly disassociating the first functional group from the second functional group, and by re-associating the first functional group with the second functional group subsequent to removal of the shear force. Thus, wet skid resistance of the tire may be relatively increased.

In various aspects and embodiments, the invention may provide one or more of a cosmetic or an adhesive that includes an energy responsive composition.

A method, provided in one embodiment, may include contacting a product of a first material and a second material with a mating surface of a substrate. The first material may have a low-temperature fluidity point and may include a first functional group. The second material may include a second functional group. The first functional group can interact with the second functional group below a threshold temperature to form a product having a viscosity greater than the viscosity of the first material or of the second material. The product may be heated to a temperature in a range that is greater than the threshold temperature to adhere to the mating surface. The product may be cooled to below the threshold temperature. The product may be reheated to above the threshold temperature to detach the product from the mating surface.

A method of forming a mold may be provided in one embodiment. The method may include adding a product to an initial mold. The product may include a first material and a second material. The first material may have a low-temperature fluidity point and may include a first functional group, and the second material may include a second functional group. The first functional group can interact with the second functional group below a threshold temperature such that the product has a viscosity greater than the viscosity of the first material or of the second material. The product may be heated to an elevated temperature that is above the threshold temperature. The product may be molded at the elevated temperature. The product may be cooled to a working-temperature that is below the threshold temperature. The product may be released from the initial mold to form a re-workable mold formed from the product. The re-workable mold may be reshaped by heating the composition in a mold above the threshold temperature and cooled to below the threshold temperature to adopt a new, different shape. Raw material may be added to the re-workable mold. The raw material may have a fluidity point that may be in a temperature range that is lower than the threshold temperature, and the reworkable mold may be used at a temperature that is greater than the fluidity point of the raw material, and that is lower than the threshold temperature of the product used to form the mold.

A method may be provided in one embodiment. The method may include contacting a first material to a second material. The first material may have a low-temperature fluidity point and may include a first functional group, and the second material may be different from the first material and may include a second functional group that is different from the first functional group. The contacting may be such that the first functional group and the second functional group form a reversible chemical bond below an energy threshold level resulting in a solid or high-viscosity composition, with the proviso that the reversible chemical bond is not a covalent bond. The first functional group may be disassociated from the second functional group by inputting energy at an energy input level above the energy threshold level to fluidize or lower the viscosity of the composition.

### DETAILED DESCRIPTION

The invention includes embodiments that may relate to an energy responsive material. Embodiments of the invention may relate to articles and/or devices that are formed from, or incorporate, the energy responsive composition. The invention includes embodiments that may relate to one or more methods of making or using the energy responsive material, or articles or devices formed therefrom.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. Fluidity point is the temperature at which the subject material flows under its own weight. The threshold energy input level is the value at which the input energy disassociates first and second functional groups from each other to a predetermined degree. The predetermined degree can be measured with reference to properties or characteristics of the subject material, such as a viscosity drop of a certain magnitude.

In one embodiment according to the invention, a product is formed from a first material and a second material. The first material may have a low-temperature fluidity point and may include a first functional group. The second material may include a second functional group, which is different from the first functional group.

The first functional group can interact with the second functional group below a threshold energy input level. The energy input may be thermal energy, in which case the threshold energy input level may be a temperature range. In another embodiment, the energy input may be mechanical shear, in which case the threshold energy input level is a shear force. Other forms of energy input that may be suited include magnetic, electromagnetic, and the like.

In response to mixing of the first material and the second material, the composition may form a product having a viscosity greater than the viscosity of either of the first material or of the second material. The association or interaction of the first functional group and the second functional group may form a supramolecule.

The composition viscosity may drop, or may be reduced, in response to the energy input at or above the energy input threshold level. Particularly, the first functional group and second functional group may disassociate, for example, to disrupt the supramolecular structure. Further, when the energy input is dropped below the energy input threshold level, the viscosity of the composition may return to or near the original, relatively elevated viscosity.

Viscosity of the energy responsive composition may be Newtonian, pseudo-plastic, or non-Newtonian. In one embodiment, a composition comprising the product may have a viscosity of about 75,000 centipoise and above, at a shear rate of about 30/second at about room temperature. In other embodiments, the viscosity may differ at other temperatures and/or shear rates, and may differ at the same shear rate and/or temperature.

With reference to the material components, the first material may include one or more organic oligomers or organic polymers. Alternatively or additionally, the first material may include one or more inorganic oligomers or inorganic polymers.

A suitable inorganic polymer may include one or more cyclic organo-siloxane, oligo-organo-siloxane, or poly(organosiloxane). In one embodiment, the poly(organosiloxane) may include a 3-aminopropylmethylsiloxane-dimethylsiloxane copolymer. In one embodiment, the poly organosiloxane consists essentially of 3-aminopropylmethylsiloxane-dimethylsiloxane copolymer. A suitable cyclic organosiloxane may include two or more aminopropyl moieties.

In one embodiment, the first functional group may include one or more base and the second functional group may include one or more acid. The first functional group and the second functional group may associate with each other to form an acid-base pair. In one embodiment, the acid group may include one or more Brønsted acid, and the base group may include one or more BrØnsted base. A suitable acid-base pair may include a salt complex. In one embodiment, the acid-base pair consists essentially of a salt complex.

In one embodiment, the acid group may include one or more Lewis acid and, the base group may include one or more Lewis base. The first functional group and the second functional group may associate with each other to form an electron donor/electron acceptor pair. In one embodiment, the electron donor/electron acceptor pair are associated via hydrogen bonding.

In one embodiment, the first functional group may include an electron rich aromatic ring, and the second functional group may include an electron deficient aromatic ring. The first material and the second material may associate with each other to form a pi-stacked supramolecular structure or product.

A suitable first functional group may include an amino group. A suitable acid group that is capable of associating with the amino group may include a carboxylic acid. In one embodiment, the first functional group consists essentially of an amino group and the second functional group consists essentially of a carboxylic acid group. A suitable second functional group may include a phosphoric acid group or a phosphorous acid group. In one embodiment, the first functional group may be a part of the second material, and the second functional group may be a part of the first material.

The low-temperature fluidity point material may have a fluidity point at a temperature in a range of less than about 200 degrees Celsius. In one embodiment, the low-temperature fluidity point material may have a fluidity point at a temperature in a range of less than about 150 degrees Celsius, less than about 100 degrees Celsius, or less than about 75 degrees Celsius. In one embodiment, the low-temperature fluidity point material may have a fluidity point at a temperature in a range of from about 25 degrees Celsius to about 50 degrees Celsius, from about 50 degrees Celsius to about 75 degrees Celsius, from about 75 degrees Celsius to about 100 degrees Celsius, or greater than about 100 degrees Celsius. In one embodiment, the low-temperature fluidity point material may have a fluidity point of about room temperature (25 degrees Celsius) or lower.

The second material may include one or more organic monomers, organic oligomers, or organic polymers. A suitable organic monomer, organic oligomer, or organic polymer may include one or more of those compositions disclosed hereinabove as suitable for the first material, with the proviso that the second material selected differs from the first material. Alternatively or additionally, the second material may include one or more inorganic materials.

Suitable inorganic material may include one or more of inorganic monomers, inorganic oligomers, or inorganic polymers. The second material may include one or more inorganic-organic hybrid materials. In one embodiment, the inorganic polymer may include a carboxylic-acid terminated oligo(dimethylsiloxane) or poly(dimethylsiloxane). Suitable siloxanes may have a chain length in a range of greater than about 5 monomeric units. In one embodiment, the siloxane chain length may be in a range of from about 5 monomeric units to about 500 monomeric units, or from about 500 monomeric units to about 1000 monomeric units.

A suitable inorganic material may include one or more inorganic salts, organometallic compounds, functionalized ceramic particulates, or metal particulates. In examples in which the second material is a particulate, the surface of the particulate may be functionalized with the corresponding second functional group. Particulates may be formed as spheres, semi-spheres, irregular surface shapes, rods, cylinders, and simple geometrical polygons, such as pyramids, cubes, or rhomboids. The particulates, independent of morphology, may be porous or non-porous, or the particulates may have a solid core or may be hollow.

Threshold energy input level is the value at which sufficient energy is added to an energy responsive composition according to an embodiment of the invention such that a response from the energy responsive composition is obtained to a predetermined amount or degree. Suitable energy input may be, for example, radiant energy or mechanical energy, or a combination thereof. Radiant energy, or radiation energy, may include, for example, thermal energy, electromagnetic energy, electrical energy, or magnetic energy. Mechanical energy may include, for example, shear force.

The threshold energy input level, where the energy input is thermal energy, may be expressed as a threshold temperature or threshold temperature range, which is discussed hereinbelow. The threshold temperature may be greater than about room temperature. In one embodiment, the threshold temperature may be in a range of greater than about 50 degrees Celsius, greater than about 75 degrees Celsius, greater than about 100 degrees Celsius to about greater than about 125 degrees Celsius, greater than about 150 degrees Celsius, or greater than about 175 degrees Celsius. In one embodiment, the threshold temperature may be in a range of from about 25 degrees Celsius to about 50 degrees Celsius, from about 50 degrees Celsius to about 75 degrees Celsius, from about 75 degrees Celsius to about 100 degrees Celsius, from about 100 degrees Celsius to about 125 degrees Celsius, from about 125 degrees Celsius to about 150 degrees Celsius, from about 150 degrees Celsius to about 160 degrees Celsius, from about 160 degrees Celsius to about 180 degrees Celsius, from about 180 degrees Celsius to about 200 degrees Celsius, or greater than about 200 degrees Celsius. Particular applications may have threshold energy input levels that differ from the above listed ranges, which are provided as illustrative examples.

The threshold shear force may be applied at shear rates in a range of greater than about 50/second (s), greater than about 100/s, greater than about 150/s, or greater than about 200/s. In one embodiment, the shear force threshold may be in a range of from about 50/s to about 100/s, from about 100/s to about 150/s, from about 150/s to about 200/s, from about 200/s to about 300/s, or greater than about 300/s.

The predetermined amount or degree of response by the composition may include a metric measuring a response defined as one or more of a drop in viscosity, a change in phase, a change in tackiness or adhesion, or the like. The drop or change may be from a measurable first amount or degree to a measurable second amount or degree.

The predetermined amount or degree of response by the composition may be controlled by, for example, the concentrations or molar ratio of the first functional group relative to the second functional group. The ratio may be in a range of from about 0.1:1 to about 1:0.1. In one embodiment, the ratio may be about 1:1. In another embodiment, the ratio may be precisely 1:1.

The composition may include one or more additives or additional materials. In one embodiment, the composition may include one or more thermally conductive fillers. Suitable filler may include one or more metals, metal alloys or low-temperature melting alloys. Other suitable filler may include one or more oxides, borides, nitrides, or carbides. Yet other suitable filler may include a carbon-based material, such as graphite, diamond, buckyball/fullerene, or carbon nanotube. In one embodiment, the filler may include one or both of aluminum oxide or boron nitride. The filler may include spherical particles, which optionally may be coated with another material (e.g., carbohydrate, binder, liquid metal, and the like).

In one embodiment according to the invention, a composition is provided that may include a first oligomeric or polymeric material and a second material. The first oligomeric or polymeric material may have a low-temperature fluidity point and may include a first functional group. The second material may be different from the first material. The second material may include a second functional group that is different from the first functional group. The first functional group and the second functional group, when contacted to each other, may form a reversible chemical bond. The bond may form when energy input to the composition is below a threshold energy input level. Bond formation may result in the composition having a relatively high viscosity or becoming solid. The first functional group and the second functional group may disassociate from each other in response to input of an amount of energy that is above the threshold level. Disassociation may lower the composition viscosity, or may fluidize or liquidize an otherwise solid composition. A proviso is that the reversible chemical bond is not a covalent bond.

Suitable energy input may include one or more of electromagnetic radiation, magnetic field, mechanical shear, or thermal energy. In one embodiment, the energy input may be mechanical shear. In one embodiment, the thermal energy, or heat, is a temperature of greater than about 50 degrees Celsius, greater than about 75 degrees Celsius, or greater than about 100 degrees Celsius. In one aspect, the viscosity drop is sharp at the threshold temperature and the initial and subsequent viscosities are very different from each other. The viscosity drop may be greater than a 10 percent drop, a 25 percent drop, a 35 percent drop, a 50 percent drop, a 75 percent drop, or an 85 percent drop in viscosity.

In one embodiment, the composition further may include a thermally conductive filler. The filler may be mixed with a first component, mixed with a second component, or may be mixed with both components after the first component and the second component have been mixed together.

Suitable heat conductive filler material may include one or more of alumina, boron nitride, aluminum nitride, silica, talc, zinc oxide, tin oxide, and the like. Other suitable filler may include particulate comprising a metal (including metalloids), such as indium, aluminum, gallium, boron, phosphorus, silver, tin, or alloys, and the like. Such fillers may be oxides, nitrides, boride, silicides, and the like, or mixtures of two or more of the foregoing. In one embodiment, a thermally conductive liquid metal may be included alone, or in addition to a particulate thermally conductive material.

Optional filler, which may or may not be thermally conductive, may include silica. Suitable silica may include one or more of fused silica, fumed silica, or colloidal silica. The filler may have an average particle diameter of less than about 500 micrometers. In one embodiment, the filler may have an average particle diameter in a range of from about 1 nanometer to about 5 nanometers, from about 5 nanometers to about 10 nanometers, from about 10 nanometers to about 50 nanometers, from about 50 nanometers to about 100 nanometers, or from about 100 nanometers to about 500 nanometers.

The filler, if present, may be present in an amount greater than about 0.5 weight percent. In one embodiment, the filler may be present in an amount in a range of from about 0.5 weight percent to about 10 weight percent, from about 10 weight percent to about 20 weight percent, from about 20 weight percent to about 30 weight percent, from about 30 weight percent to about 40 weight percent, from about 40 weight percent to about 50 weight percent, from about 50 weight percent to about 60 weight percent, from about 60 weight percent to about 70 weight percent, from about 70 weight percent to about 80 weight percent, from about 80 weight percent to about 90 weight percent, or greater than about 90 weight percent, based on the total weight of the composition.

Optionally, a composition according to the invention may include a flame retardant. Suitable flame retardants may include one or more of triphenyl phosphate (TPP), resorcinol diphosphate (RDP), bisphenol-a-diphosphate (BPA-DP), organic phosphine oxide, halogenated resin (e.g., tetrabromobisphenol A), metal oxide, metal hydroxide, and the like. Other suitable flame retardants may include a compound selected from the class of phosphoramide compounds.

Flame retardants, if used, may be present in an amount greater than about 0.5 weight percent based on the total weight of the composition. In one embodiment, the flame retardants may be present in an amount in a range of from about 0.5 weight percent to about 1 weight percent, from about 1 weight percent to about 1.5 weight percent, from about 1.5 weight percent to about 2.5 weight percent, from about 2.5 weight percent to about 3.5 weight percent, from about 3.5 weight percent to about 4.5 weight percent, from about 4.5 weight percent to about 5.5 weight percent, from about 5.5 weight percent to about 10 weight percent, from about 10 weight percent to about 15 weight percent, from about 15 weight percent to about 20 weight percent, or greater than about 20 weight percent, based on the total weight of the composition.

In one embodiment, the composition according to an embodiment of the invention may be transparent. Transparent includes the ability to see and distinguish features while looking through a predetermined thickness of a layer of the composition. In one embodiment, transparent is defined according to ASTM D 1746-97 and/or ASTM D 1003-00, as applicable.

In another aspect, the invention may provide an electronic apparatus. The electronic apparatus may include a heat-generating unit having a surface; a heat-dissipating unit having a surface; and the energy responsive composition as disclosed above, optionally with the thermally conductive filler. The composition may be disposed on at least one of the heat-dissipating unit surface, on the heat-generating unit surface, or on both surfaces. This may provide a thermal interface and thermal transport from the heat-generating unit to the heat-dissipating unit. The so-formed thermal interface material may be re-worked or may be re-workable.

Suitable heat-dissipating components may include one or more of a heat sink, a heat radiator, heat spreader, heat pipe, or a Peltier heat pump. Suitable heat-generating devices may include one or more of an integrated chip, a power chip, power source, light source (e.g., LED, fluorescent, or incandescent), motor, sensor, capacitor, fuel storage compartment, conductor, inductor, switch, diode, or transistor.

An aspect of the invention may relate to a re-workable underfill material for use between a chip and a substrate. The underfill may allow for relative ease of removal of component parts of electronic assemblies.

The invention also provides a rubber article that may include the energy responsive composition. A tire may be formed from the rubber article. In one embodiment, the tire may respond to shear force by reversibly disassociating the first functional group from the second functional group, and re-associating the first functional group with the second functional group subsequent to removal of the shear force. Such responsiveness may increase wet skid resistance of the tire as measured by, for example, F408 “Standard Test Method for Wet Traction Braking”; F1650-98 “Standard Practice for Evaluating Tire Traction Performance Data Under Varying Test Conditions”; F377-03 “Standard Practice for Calibration of Braking/Tractive Measuring Devices for Testing Tires”; the contents of which are hereby incorporated by reference to the extent that they disclose wet skid resistance measurement procedure and terminology. The Uniform Tire (Tyre) Quality Grading System (UTQG) may be used to rate and evaluate a tire including an embodiment of the invention. In one embodiment, such a tire may be rated as better than Treadwear:200 Traction:A Temperature:A, and in other embodiments, differing UTQG ratings may be obtained.

In one embodiment related to a rubber tire including a composition according to the invention, the threshold temperature is in a range of from less than 0 degrees Celsius to about 180 degrees Celsius. In one embodiment, the energy input threshold is a temperature in a range of from about minus 70 degrees Celsius to about minus 50 degrees Celsius, from about minus 50 degrees Celsius to about minus 25 degrees Celsius, from about minus 25 degrees Celsius to about minus 10 degrees Celsius, or from about minus 10 degrees Celsius to about 0 degrees Celsius.

In another aspect, a personal care cosmetic is provided that may include the energy responsive composition. In one embodiment, the threshold temperature is about body temperature. For use in the cosmetic, the composition may be one or more of non-toxic, non-sensitizing, or non-irritating to skin, particularly human skin. Additionally, the composition may be non-irritating to eyes and/or mucous membranes.

An adhesive including the energy responsive composition may be provided in another aspect. In one embodiment, the adhesive may be tacky at a temperature in a range above the threshold temperature, and may be relatively non-tacky at a temperature in a range below the threshold temperature. Such an adhesive may be used in applications where, for example, heat-responsive strippable adhesives may be employed. The adhesive may be formed as a layer on a substrate surface.

The level of adhesion may be very high, or may be very low, as determined by application specific parameters. For low-level adhesion materials, particularly pressure-sensitive adhesives, the adhesion level is such that the adhesive is tacky and adheres in response to light finger pressure. For high-level adhesion materials, particularly structural adhesives, the adhesion level is such that the adhesive may hold substrates to which it is adhered tenaciously together. Regardless of adhesion level, below the energy input threshold, for example temperature, the adhesive film may behave as a traditional adhesive. Above the energy input threshold, the adhesive film properties or characteristics switch to different properties or characteristics relative to below the energy input threshold. The properties or characteristics above the energy input threshold may include a decrease in one or more of body, adhesion, viscosity, tack, heat deflection temperature (HDT), or opacity for the film; or an increase in one or more of flexibility, conformity, elasticity, and the like for the film. Such properties being described and measured by a corresponding ASTM standard.

Suitable energy responsive compositions may be employed in applications, such as thermal management (e.g. as a thermal interface material), by contacting the energy responsive composition with a mating surface of a substrate. The energy responsive composition may include the product of a first material and a second material. The first material may include a low-temperature fluidity point and may include a first functional group. A second material may include a second functional group. The first functional group can interact with the second functional group below a threshold temperature to form the product, which has a viscosity greater than the viscosity of the first material or of the second material. The product may be heated to a temperature in a range that is greater than the threshold temperature. Subsequently, the product may be cooled to below the threshold temperature to form a film, sheet or pad on the mating surface. Optionally, the product may be reheated to above the threshold temperature to detach the composition from the mating surface.

In one aspect, an embodiment of the invention may provide a method of forming a mold. The method may include adding a composition to an initial mold. The product may include a first material having a low-temperature fluidity point having a first functional group; and a second material having a second functional group. The first functional group can interact with the second functional group to form a product below a threshold temperature, which may have a viscosity greater than the viscosity of the first material or of the second material. The method may continue by heating the product to an elevated temperature that is above the threshold temperature. Molding of the product may be performed at the elevated temperature. The product may be cooled to a working temperature that is below the threshold temperature, and the product may solidify. The product, cooled, may be released from the initial mold to form a re-workable mold. The reworkable mold may be reshaped or modified by re-heating to above the threshold temperature in the original mold or a different mold. Subsequently, raw material may be added to the re-workable mold. The raw material may have a fluidity point that is in a temperature range that may be lower than the threshold temperature, and working temperature of the reworkable mold may be in a range that may be greater than the fluidity point of the raw material, and may be lower than the threshold temperature of the material used to form the reworkable mold.

In another aspect, an embodiment of the invention may provide a method that may include contacting a first material to a second material below a threshold temperature. The first material may have a low-temperature fluidity point and may include a first functional group. The second material may be different from the first material and may include a second functional group that is different from the first functional group, and the contacting is such that the first functional group and the second functional group may form a reversible chemical bond resulting in a solid or high-viscosity composition. The proviso is that the reversible chemical bond is not a covalent bond. The method may continue with disassociating the first functional group from the second functional group by inputting energy to fluidize or lower the viscosity of the composition. In one embodiment, the energy may be thermal energy, or the energy may be mechanical energy.

Optionally, the method may further continue by contacting the product to a surface of a heat-dissipating unit. Additionally or alternatively, the composition may be contacted to a surface of a heat-generating unit.

### EXAMPLES

The following examples are intended only to illustrate methods and embodiments in accordance with the invention, and as such should not be construed as imposing limitations upon the claims. Unless specified otherwise, all ingredients are commercially available from such common chemical suppliers as Alpha Aesar, Inc. (Ward Hill, Mass.), Spectrum Chemical Mfg. Corp. (Gardena, Calif.), Gelest (Tullytown, Pa.), GE Silicones (Waterford, N.Y.), and the like. Chain lengths of silicones, and the like, may be determined by NMR.

### Example 1

### Synthesis of Carboxylic-Acid Terminated Poly(dimethylsiloxane)

Example 1 includes the preparation of carboxylic-acid terminated poly(dimethylsiloxane)s Sample 1 through Sample 3. The Samples 1 through 3 have the following structure of formula (I):

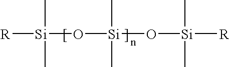

| | R | n |
|---|---|---|
| sample 1 | 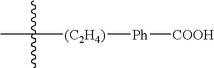 | 43 |
| sample 2 | 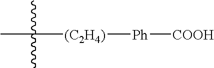 | 110 |
| sample 3 | 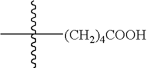 | 40 |

For Sample 1, the following procedure is used. 5.00 grams of 4-vinylbenzoic acid is dissolved in 60 ml of anhydrous toluene under nitrogen to form a solution. 5.44 grams of hexamethyldisilazane (1 equivalent) is added to the solution to form a mixture. The mixture is refluxed under nitrogen for 3 hours.

An initially-formed white precipitate disappears after 1.5 hour of reflux. The reaction is considered complete if nothing precipitates from the solution at minus 78 degrees Celsius. The completion of reaction is monitored by integral of the SiMe₃ resonance at 0.43 ppm in proton NMR spectrum (CDCl₃). The resultant product is a yellow solution of trimethylsilyl-(4-vinyl)-benzoate.

The prepared yellow solution of trimethylsilyl-(4-vinyl)benzoate is added to a solution of 56.07 grams of HSiMe₂—(O—SiMe₂)₄₃—OSiMe₂H (M^{H}D₄₃M^{H}) in anhydrous toluene (100 ml). 5 ml of 1,4-dioxane are added gradually to achieve dissolution of trimethylsilyl-(4-vinyl)-benzoate. One hundred ppm of a platinum (Pt) catalyst (Karsdt-type) in xylene solution is added to the resultant mixture, and is stirred at 60 degrees Celsius to 70 degrees Celsius for 2 hours. Two equivalents (with respect to the Pt) of triphenylphosphin (PPh₃) are added to form a second mixture, and the second mixture is stirred for 20 min. A copious amount of carbon black is added to the second mixture and is stirred for 16 hours. The carbon black is removed by filtration, and volatiles are stripped off using a ROTAVAP at 0.2 torr and 60 degrees Celsius to 70 degrees Celsius to afford a viscous colorless fluid. The excess of triphenylphosphin is removed by vacuum sublimation at 130 degrees Celsius.

The remaining liquid is dissolved in 1,4-dioxane in 1:2 proportion, and water is added until a phase separation is observed. The mixture is stirred at 60 degrees Celsius to 70 degrees Celsius for 1 hour. Volatiles are removed first on ROTAVAP and then by evaporation under vacuum. The completion of hydrolysis is controlled by the absence of the resonance at 0.43 ppm in proton NMR spectrum and Sample 1 is formed. Hydrosilylation occurs in both 1,2 (—CH₂—CH₂— bridge formation) and 2,1 (—CH(Me)- bridge formation) ways in 47.5:52.5 proportion. The following NMR data may verify the structure indicated in formula (I).

¹H NMR (CD₂Cl₂, 25 degrees Celsius, 400 MHz, ppm δ): 8.04 d (J_{H-H}=8.1 Hz), CH^{ar}—C^{q}—COOH, 1.9 H; 8.1 d (J_{H-H}=7.7 Hz), CH^{ar}—C^{q}—COOH, 2.1 H; 7.36 d (J_{H-H}=8.3 Hz), CH^{ar}—C^{q}—CH₂—, 1.9 H; 7.25 d (J_{H-H}=7.3 Hz), CH^{ar}—C^{q}—CH<, 2.1 H; 2.78 m, Ph-CH₂—, 1.9 H; 2.37 q (J_{H-H}=7.6 Hz), CH₃—CH<, 1.05 H; 1.45 d (J_{H-H}=7.6 Hz), CH₃—CH<, 3.15 H; 0.98 m, —CH₂—Si≡, 1.9 H; 0.12 s, OSi(CH₃)₂, 258.5 H. ¹C NMR (CDCl₃, 25 degrees Celsius, 470 MHz, ppm δ): 172.33 COOH, 172.13 COOH, 152.61 C^{q}—COOH, 152.03 C^{q}—COOH, 132.15 C^{q}—CH<, 132.05 C^{q}—CH₂—, 130.24 C^{ar}, 129.91 C^{ar}, 127.99 C^{ar}, 127.36 C^{ar}, 32.30 —CH₂-Ph, 29.59 CH₃—CH<, 19.87 —CH₂—Si≡, 13.86 CH₃—CH<, 0.90 —O—Si(CH₃)₂—C₂H₄-Ph, 0.77 —O—Si(CH₃)₂—.

For Sample 2 the following procedure is used. Sample 2 is prepared in the same manner as described for Sample 1, except for the following: 2 grams of 4-vinylbenzoic acid and 55.8 grams of Product 89184, Si—H terminated PDMS fluid from GE Silicones, are used.

The NMR analysis coincides with that of Sample 1.

For Sample 3 the following procedure is used. A 100 ml round bottom flask is charged with 8.0 grams of 4-pentenoic acid (used as received from Aldrich), 50 ml of anhydrous toluene and 12.8 grams of hexamethyldisilazane in a nitrogen glove box to form a mixture. The mixture is refluxed under nitrogen for 3 hours. An initially-formed white precipitate disappears after 1 hour of reflux. The completion of reaction is monitored by integral of the SiMe₃ resonance at 0.25 ppm in proton spectrum (CDCl₃). The product is distilled at 161 degrees Celsius to afford colorless trimethyl silyl pentenoate (CH₂═CHCH₂CH₂COOSiMe₃).

An amount of trimethylsilyl pentenoate (6.12 g) is mixed with 49.46 grams of HSiMe₂—(O—SiMe₂)₄₀—OSiMe₂H (M^{H}D₄₀M^{H}) under nitrogen to form a mixture. One hundred ppm of a Pt catalyst in toluene is added to the mixture. After 1 hour of stirring at room temperature (reaction is slightly exothermic) the reaction completion of a brown product is determined or based on NMR analysis. The brown product is dissolved in 200 ml of toluene-methylene chloride 1:1 mixture. Two equivalents (respect to Pt) of PPh₃ are added to form a mixture, and the mixture is stirred for 20 min. A copious amount of carbon black is added, and the mixture is stirred for 16 hours. Carbon black is removed by filtration, and volatiles are stripped off by ROTAVAP and are removed under 0.2 torr at 60-70 degrees Celsius to afford a viscous slightly yellow fluid. The excess of triphenylphosphin is removed by vacuum sublimation at 130 degrees Celsius.

A remaining liquid is dissolved in 1,4-dioxane in 1:2 proportion. Water is added until a phase separation is observed and a mixture is formed. The mixture is stirred at 60 degrees Celsius to 70 degrees Celsius for 1 hour. Volatiles are removed first on ROTAVAP and then under vacuum. The completion of hydrolysis is controlled by the absence of the resonance at 0.30 ppm in proton NM spectrum and Sample 3 is formed. Hydrosilylation occurs in 1,2 (—CH₂—CH₂— bridge formation) mode only. The following NMR data may verify the structure.

¹H NMR (CD₂Cl₂, 25 degrees Celsius, 400 MHz, ppm δ): 2.37 tr (J_{H-H}=7.6 Hz), HOOC—CH₂—, 2.0 H; 1.69 p (J_{H-H}=7.6 Hz), HOOC—CH₂—CH₂—, 2.01 H; 1.41 m, —CH₂—CH₂—S≡, 2.02 H; 0.58 m, —CH₂—Si≡, 2.10 H; 0.10 s, OSi(CH₃)₂, 120 H.

### Example 2

### Preparation of 1,3,5,7-Tetrakis (3-propylamino)-1,3,5,7-tetramethylcyclotetrasiloxane, Sample 4.

A generalization of the reaction scheme is shown in formula (II), below:

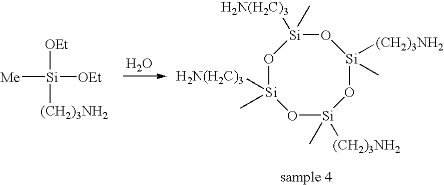

A mixture of 100 grams of NH₂(CH₂)₃SiMe(OEt)₂ (Gelest, Inc. (Morrisville, Pa.) used as received), 100 grams of toluene, 50 grams of water and 1 grams of KOH (powder) is refluxed for 30 min in a 0.5 L round bottom 1 neck flask, followed by slow distillation of volatiles under atmospheric pressure. A hot colorless viscous residue is further distilled under 0.1 torr to 0.2 torr with a 20 cm fractional distillation column collecting a fraction (Sample 4) within 170 degrees Celsius to 182 degrees Celsius. Sample 4 is obtained in 85% yield. The remainder is composed of higher siloxanes. No cyclo trisiloxane formation is observed. Viscosity of freshly distilled colorless liquid (Sample 4) is 110 centipoise, and tends to thicken over time.

If the product is not distilled immediately after the volatiles removal and allowed to cool down to room temperature, it solidifies. In this case, it has to be melted in oven at 150 degrees Celsius with addition of 1 gram to 2 grams of water prior to vacuum distillation. The following NMR and Mass spectrometry data may verify the structure.

¹H NMR (CDCl₃, 25 degrees Celsius, 400 Mhz, ppm δ): 2.65 tr (J_{H-H}=7.1 Hz), H₂N—CH₂—, 2.0 H; 1.81 br.s NH₂—, 2.08 H; 1.46 m, H₂N—CH₂—CH₂—, 2.02 H; 0.51 m, —CH₂—Si≡, 2.0 H; 0.07 s, OSiCH₃, 3.0 H. ²⁹Si NMR (CDCl₃, 25 degrees Celsius, 119 MHz, δ): −19.77. MS: 468 (M⁺), 451, 438, 410, 392 (100%), 381, 367, 352, 338, 324, 305,292, 279, 266, 252, 217.

### Example 3

### Preparation of Vinyl-Terminated 3-aminopropylmethylsiloxane-dimethylsiloxane Copolymers Samples 5 and 6.

A generalization of the reaction scheme is shown in formula (III), below:

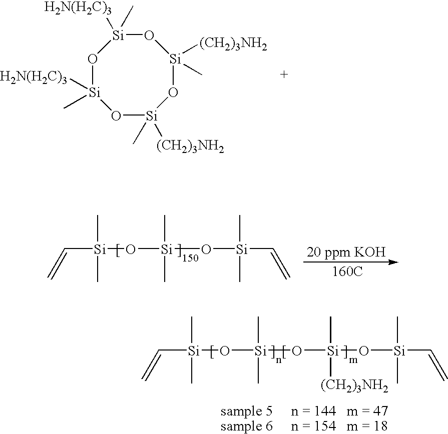

Samples 5 and 6 are prepared by a KOH-catalyzed (100 ppm) re-distribution reaction between Sample 4 and a vinyl-terminated poly(dimethylsiloxane) polymer (SL6000, GE Silicones (Waterford, N.Y.) at 160 degrees Celsius over the course of 12 hours. The liquids are not initially miscible. The mixtures become mono-phase after 40 minutes to 60 minutes at 120 degrees Celsius to 160 degrees Celsius. After reaction completes, the mixtures are cooled to room temperature and quenched with an amount of glacial acetic acid. Volatiles (cyclic products) are removed at 160 degrees Celsius under 0.1 torr with stirring. The formation of volatiles does not exceed 12.5%. The number of dimethylsiloxane (n) and 3-aminopropylmethylsiloxane (m) units are determined on the basis of ¹H NMR spectral peak integration. The following NMR data may verify the structure.

¹H NMR (CDCl₃, 25 degrees Celsius, 400 Mhz, δ): 6.2-5.7 CH₂═CH— system, 2.67 tr (J_{H-H}=7.1 Hz), H₂N—CH₂—; 1.84 br.s NH₂—; 1.49 m, H₂N—CH₂—CH₂—; 0.51 m, —CH₂—Si≡; 0.17 s, —OSi(CH₃)₂Vi; 0.08 s, —OSi(CH₃)₂—+—OSi(CH₃)C₃H₆NH₂—. ²⁹Si NMR (CDCl₃, 25 degrees Celsius, 119 MHz, δ): −21.45 (3%), −21.76 (64%), −21.88 (15%), −22.19 (7%)+smaller resonances.

Properties of the starting materials and products are summarized in Table 1.

TABLE 1
Properties of SL6000, Sample 4, Sample 5 and Sample 6.

| Property | SL6000 | Sample 4 | Sample 5 | Sample 6 |
|---|---|---|---|---|
| mol % N* | 0 | 100 | 24.4 | 10.3 |
| Mw | 11,260 | 469 | 16,420 | 13,690 |
| n/m | 150/0 | 4/4 | 144/47 | 154/18 |
| g/equiv N | — | 117 | 348 | 760 |
| d, g/cm³ | 0.98 | 0.98 | 0.97 | 0.97 |

*mol % N = m/(n + m)

### Example 4

### Formation of Network Structure

The first material and the second material are mixed together with a spatula. The maximum viscosities of the resultant mixtures are attained after several hours. The time to equilibria can be shortened by heating the mixture to 70 degrees Celsius or higher temperature, while under shear for several minutes, and then allowing the mixture to cool down to room temperature.

The following compositions (Samples 7-14) are prepared:

TABLE 2
Molar ratios of first functional group to second functional group.

| | First | Second | |
|---|---|---|---|
| | material/first | material/second | Molar ratio of |
| | functional | functional | amino:carboxylic |
| Samples | group (g) | group (g) | acid* |
| 7 | Sample 5 | Sample 2 | 1:1 |
| | (0.0205) | (0.2523) | |
| 8 | Sample 5 | Sample 2 | 1:2 |
| | (0.0208) | (0.5036) | |
| 9 | Sample 5 | Sample 2 | 2:1 |
| | (0.0406) | (0.2536) | |
| 10 | Sample 6 | Sample 2 | 1:1 |
| | (0.045) | (0.2516) | |
| 11 | Sample 4 | Sample 2 | 1:1 |
| | (0.0135) | (0.5049) | |
| 12 | Sample 6 | Sample 1 | 1:1 |
| | (0.0849) | (0.2071) | |
| 13 | Sample 4 | Sample 1 | 1:0.94 |
| | (0.0331) | (0.5011) | |
| 14 | Sample 4 | Sample 3 | 1:1 |
| | (0.024) | (0.316) | |

*Molar ratio of amino group:carboxylic acid group

### Example 5

### Rheological Properties and Affecting Factors

Viscosities of Samples 7-14 are measured on a Brookfield CAP 2000+ Viscometer using a size 6 spindle. The viscosities of Sample 1 through Sample 6 are measured on the Brookfield CAP 2000+ Viscometer using a size 1 spindle. The relationship between shear rate and rpm is shear rate (/s)=3.33×rpm for a size 6 spindle; and shear rate=13.33×rpm for a size 1 spindle. Table 3 lists the viscosity measurements of Samples 1-14 (in Poise).

TABLE 3
Viscosity measurements of Samples 1-14 (in Poise).

| | Molar | 25° C. | | 75° C. | |
|---|---|---|---|---|---|
| Sample | ratio** | 30 rpm (P) | 100 rpm (P) | 30 rpm (P) | 100 rpm (P) |

| | | | |
|---|---|---|---|
| 1* | — | 6.5-7.5 | ˜1.3 |
| | | (5 rpm-100 rpm) | (5 rpm-100 rpm) |
| 2* | — | 11-12 | 3.2-3.5 |
| | | (5 rpm-100 rpm) | (5 rpm-100 rpm) |
| 3* | — | 1.3-3.8 | 0.4-3.4 |
| | | (5 rpm-200 rpm) | (5 rpm-400 rpm) |
| 4* | — | 15-19 | 1.7-4.9 |
| | | (5 rpm-200 rpm) | (5 rpm-200 rpm) |
| 5* | — | 3.5-7.1 | 0.8-4.6 |
| | | (5 rpm-200 rpm) | (5 rpm-200 rpm) |
| 6* | — | 3.2-7.1 | 0.9-4.5 |
| | | (5 rpm-200 rpm) | (5 rpm-200 rpm) |

| | | | | | |
|---|---|---|---|---|---|
| 7 | 1:1 | 2256 | 156 | 175 | 175.5 |
| 8 | 1:2 | 105 | 87.7 | 30 | 20.3 |
| 9 | 2:1 | 950 | 141.8 | 102 | 91.5 |
| 10 | 1:1 | 960 | 251.3 | 98 | 79.5 |
| 11 | 1:1 | 5497 | 3500 | 603 | 20.3 |
| 12 | 1:1 | 1862 | 210 | 95 | 81 |
| 13 | 1:0.94 | Solid | Solid | 550 | 570 |
| 14 | 1:1 | 2200 | 563 | 158 | 79 |

*The viscosity values obtained at 5 rpm may have considerable associated error and are expressed as a range.
**Molar ratio of amino group:acid group

The first material and the second material as indicated in Tables 2 and 3, separately, are low viscosity fluids under the conditions investigated. Upon mixing, a composite formed from the mixing of the first and second materials increases in viscosity below the threshold temperature, and after shear force is removed. The composite viscosity is responsive or sensitive to external stimuli such as shear, temperature, or both. Either high shear (100 rpm vs. 30 rpm at 25 degrees Celsius) or high temperature (75 degrees Celsius vs. 25 degrees Celsius) cause a decrease in composite viscosity. The dependence of viscosity on shear at 75 degrees Celsius was less than that at room temperature.

The composite viscosity can be controlled as a function of molar ratio of amino (samples 7-9), concentrations of acid groups (sample 10 vs. 12 and sample 11 vs. 13), concentrations of amino groups (sample 7 vs. 10 vs. 11; 12 vs. 13), and pKa values (samples 13 vs. 14).

Aminopropyl-substituted PDMS fluid has a stronger association with more acidic (lower pKa) benzoic-acid-terminated PDMS than with aliphatic carboxylic acid stopped PDMS as evidenced from the relative chemical shifts of the resulting amino-salt peaks, the onset temperature for the amino-salt dissociation, and the temperature at which irreversible amide formation occurred (see Table 4).

TABLE 4
Threshold temperature range determination for select examples.

| | 1:1 mixture of | 1:1 mixture of |
|---|---|---|
| | Sample 1:Sample 4 | Sample 3:Sample 4 |
| chemical shift of R₃NH⁺ | 11.5 | multiple from 2.8 to 6.9 |
| (ppm) | | |
| Onset temperature for | 85-90 | 45-50 |
| salt dissociation | | |
| (° C.) | | |
| Minimal temperature for | 145 | 100-110 |
| amide bond formation | | |
| (° C.) | | |

The network formation is controlled by the sterics of the functional groups. For example, no appreciable viscosity increase is observed when a carboxylic-acid stopped PDMS is mixed with tetra (N,N′-dimethyl-aminopropyl) tetramethyl cyclo tetrasiloxane) (1:1 acid:amino), nor any appreciable chemical shift for the R₃NH⁺ peak.

After the external stimuli (e.g, shear rate or high temperature) is removed, the system does not always return to the original equilibria immediately. For example, a mixture of 0.2566 grams Sample 2 and 0.0490 grams Sample 4 has a viscosity of 1263 Poise at 25 degrees Celsius under a shear rate of 100/s. The mixture is heated to 75 degrees Celsius and has its viscosity measured at 100/s (88 Poise) and 333/s (84 Poise). The mixture is then cooled to 25 degrees Celsius, and a measurement of viscosity at 100/s is taken immediately afterwards (<5 minutes) with a reading of 528 Poise. This measurement of viscosity is lower than the original viscosity value obtainable under the same experimental conditions. After 30 minutes, the measurement is taken again at 100/s, with a reading of 1250 Poise, similar to the original value. This example demonstrates the reversibility of the binding between the first material and the second material.

### Example 6

### TIM Applications

Sample 15 is prepared by mixing 1.5023 grams of Sample 2 with 0.8181 grams of boron nitride (PTX60, GE Advanced Ceramics) on a speed-mixer ((FlackTek Inc., Model # DAC400FV) for 2×10 seconds at 2000 rpm, and another 2×10 seconds at 2749 rpm. Sample 5 at 0.1243 grams is added, and the mixture is blended by hand until a consistent viscosity is achieved (final formulation contains 33.5% BN). The mixture is put in a vacuum oven for 12+ hours (70 degrees Celsius, greater than 100 torr). Afterwards, the mixture is allowed to cool down slowly under a stream of nitrogen. The composite appears as a heavily loaded thermal gel or grease material, with interactions between the benzoic acid group and the aminopropyl group.

The mixture is interposed between one aluminum and one silicon substrate at 70 degrees Celsius and under 10 psi load to yield one 3-layered structure, where the mixture acts as a thermal interface material (TIM). Five such structures (Samples 15a through 15e) were prepared. Sample 15 is an average of the Samples 15a through 15e. The bond line thickness of each sample was determined as follows: for each coupon (Al and Si) before assembly and for each 3-layered structure after assembly or after torquing, five thickness measurements are taken—four at the corners and one in the center. The measurements are then averaged to yield the average thickness of the coupons or the 3-layered structures. The bond line thickness of the TIM layer for each 3-layered structure is taken as the difference between the thickness of the 3-layered structure and the sum of the two coupon thicknesses.

The in situ thermal performance of TIM is measured by a Microflash 300 manufactured by Netzsch Instrument. In the test, bolts and a torque wrench are used to apply a specific torque that translates to a particular pressure (psi) on each of the 3-layered samples. Samples 15a-15e are measured at 25 degrees Celsius, with a 30 psi load. The samples are then heated to 100 degrees Celsius, re-torqued to 30 psi, and new measurements are taken.

### Example 7

Sample 1 and Sample 4 (1:1 carboxylic acid aminopropyl ratio) and BN (33% of the final formulation, PTX60, GE Advanced Ceramics) are mixed to form Sample 16, which is prepared in the same manner as in Example 6. Five sandwiched structures are constructed using Sample 16 (Samples 16a through 16e). The performance of Sample 16 as TIM is evaluated. At room temperature, Sample 16 is an average of the Samples 16a-16e, and has a clay-like consistency, but softens at higher temperatures. Clay-like is a semi-solid, non-tacky state that is moldable by hand. This ability allows Sample 16 to be used as a phase changeable thermal interface material.

### Example 8

A mixture of Sample 2, Sample 4 (1:1 carboxylic acid aminopropyl ratio) and BN (33% of the final formulation, PTX60, GE Advanced Ceramics) is mixed to form Sample 17, and is prepared as above. Five sandwiched structures are constructed using Sample 17 (an average of Samples 17a through 17e). The performance of Sample 17 as TIM is evaluated. BLT refers to bond line thickness, Tc refers to in situ thermal conductivity and TR refers to in situ thermal resistivity.

TABLE 5
test results under different test conditions.

| | | Temp | | | |
|---|---|---|---|---|---|
| | Pressure | (de- | BLT | Tc | TR |
| Sample | (PSI) | grees C.) | (mils) | (W/mK) | (mm\hat{ }2 K/W) |
| 15 | 30 | 25 | 2.3 ± 0.1 | 3.5 ± 0.4 | 17 ± 2 |
| 15 | 30 | 100 | 1.7 ± 0.1 | 4.9 ± 0.4 | 9 ± 1 |
| 16 | 30 | 25 | 2.3 ± 0.1 | 2.5 ± 0.3 | 23 ± 2 |
| 16 | 30 | 100 | 1.8 ± 0.3 | 5.0 ± 0.8 | 9.5 ± 2.4 |
| 17 | 30 | 25 | 2.6 ± 0.2 | 2.8 ± 0.3 | 24 ± 3 |
| 17 | 30 | 100 | 2.1 ± 0.24 | 4.6 ± 1.0 | 12 ± 2.5 |

*Tc is thermal conductivity,
TR is thermal resistivity.

Sample 17 has reduced viscosity at high temperatures, leading to a relatively reduced bond line thickness. In addition, the reduced viscosity allows better wetting of the material with the substrates, as indicated by the increase in situ thermal conductivity at higher temperature. The reduction in bond line thickness and the increase in situ thermal conductivities leads to a 50 percent reduction to 60 percent reduction in situ thermal resistance at high temperatures.

### Example 9

Sample 2 (3.5604 grams) is mixed with 25.375 grams of alumina (4:1 DAW05:AA04, DAW05 obtained from Denka, and AA04 from Sumitomo) to form a mixture. To this mixture, 0.290 grams Sample 5 is added, and mixed until a material resembling heavily loaded TIM grease is obtained. The resulting product is interposed between two aluminum coupons at 90 degrees Celsius and under a 10 psi load for 10 minutes to yield a three-layered sandwich structure. Five sandwich structures (Sample 18a to Sample 18e) are prepared. Sample 18 is an average of Sample 18a to Sample 18e. The in-situ thermal performance of each of Samples 18a-18e as TIM is measured by a MICROFLASH 300 manufactured by Netzsch Instrument. In the test, bolts and a torque wrench apply a specific torque that translates to a particular pressure (psi) on each of the 3-layered sandwich structures of Samples 18a-18e.

Samples 18a-18e are loaded into test vehicles, and torqued to 110 psi. The bond line thickness is determined and the in situ thermal performance at room temperature is measured with the MICROFLASH instrument. Samples 18a-18e are taken out of the test vehicles, and reloaded for the measurement at 100 degrees Celsius. After reloading into the test fixtures, Samples 18a-18e are re-torqued to 110 psi (at room temperature). The bond line thicknesses of the TIM layers are re-measured. The test vehicles are heated to 100 degrees Celsius, and the thermal resistance measurements are taken. Samples 18a-18e are not re-torqued before the measurements were taken at 100 degrees Celsius. Because 18a-18e soften at 100 degrees Celsius with significantly reduced viscosity, the bond line thickness of the TIM layer between the aluminum coupons is reducible, thus relieving force exerted by the bolts. Consequently, without re-torquing before the measurement, effective pressure experienced by the Samples 18a-18e at 100 degrees Celsius is less than 110 psi.

### Example 10

Sample 19 is prepared to include 3.022 g of Sample 2, 21.067 grams alumina and 0.138 grams of Sample. Five sandwiched structures are constructed using Sample 19 (Samples 19a through 19e). Sample 19 is prepared and tested in the same was as Example 6.

### Example 11

Sample 20 is prepared to include 3.20 grams of Sample 1, 22.754 grams alumina and 0.2 grams of Sample 4. Sample 20 is prepared and tested according to procedures outlined in Example 6. Five sandwiched structures are constructed using Sample 20 (Samples 20a through 20e). At room temperature, the mixture is hard and clay-like, but softens to a pliable thermal grease-like material at higher temperatures.

TABLE 6
test results for Samples 18, 19 and 20. BLT refers to bond line
thickness, T_{C} refers to in situ thermal conductivity and TR
refers to in situ thermal resistivity.

| | Pressure | | BLT | Tc | TR |
|---|---|---|---|---|---|
| Example | (PSI) | Temp (C.) | (mils) | (W/mK) | (mm\hat{ }2 K/W) |
| Sample 18 | 110 | 25 | 0.8 ± 0.2 | 1.5 ± 0.4 | 15 ± 0.4 |
| Sample 18 | <110 | 100 | 0.7 ± 0.1 | 1.2 ± 0.2 | 14 ± 0.8 |
| Sample 19 | 110 | 25 | 1.6 ± 0.5 | 2.6 ± 0.8 | 15 ± 1 |
| Sample 19 | <110 | 100 | 1.0 ± 0.1 | 1.7 ± 0.2 | 15 ± 0.3 |
| Sample 20 | 110 | 25 | 1.7 ± 0.2 | 2.5 ± 0.4 | 18 ± 2 |
| Sample 20 | <110 | 100 | 1.0 ± 0.1 | 1.7 ± 0.1 | 15 ± 2 |

Formulations show reduction in bond line thicknesses at higher temperatures (due to the re-torquing after re-loading the samples into the test vehicles), and the reduction is more significant for formulations whose base resins (a mixture of first and second materials, without fillers) have initial higher viscosities (Samples 19-20 vs. Sample 18). This may be due to the reduced pressure at 100 degrees Celsius.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A composition comprising the product of:
a first material having a low-temperature fluidity point comprising a first functional group; and
a second material comprising a second functional group,
wherein the first functional group can associate with the second functional group below a threshold temperature to form a product having a viscosity greater than the viscosity of the first material or of the second material.

2. The composition as defined in claim 1, wherein the first functional group can disassociate from the second functional group in response to the application of energy to the product.

3. The composition as defined in claim 1, wherein the first functional group comprises a base and the second functional group comprises an acid, and the first material and the second material are operable to form an acid-base pair.

4. The composition as defined in claim 3, wherein the first functional group comprises a BrØnsted base, and the second functional group comprises a BrØnsted acid.

5. The composition as defined in claim 3, wherein the first functional group comprises a Lewis base, and the second functional group comprises a Lewis acid.

6. The composition as defined in claim 3, wherein the acid-base pair comprises a salt complex.

7. The composition as defined in claim 3, wherein the second functional group comprises a carboxylic acid group.

8. The composition as defined in claim 3, wherein the first functional group comprises a nitrogen-containing moiety.

9. The composition as defined in claim 3, wherein the first functional group consists essentially of an amino group, and the second functional group consists essentially of a carboxylic acid group.

10. The composition as defined in claim 3, wherein the second functional group comprises phosphoric acid group or a phosphorous acid group.

11. The composition as defined in claim 1, wherein the first material comprises one or more organic oligomers or organic polymers.

12. The composition as defined in claim 1, wherein the first material comprises one or more inorganic oligomers or inorganic polymers.

13. The composition as defined in claim 12, wherein the inorganic polymer comprises one or more cyclic organo-siloxane, oligo(organosiloxane), or poly(organosiloxane).

14. The composition as defined in claim 13, wherein the poly(organosiloxane) comprises 3-aminopropylmethylsiloxane-dimethylsiloxane copolymer.

15. The composition as defined in claim 13, wherein the poly(organosiloxane) consists essentially of 3-aminopropylmethylsiloxane-dimethylsiloxane copolymer.

16. The composition as defined in claim 13, wherein the cyclic organosiloxane comprises two or more aminopropyl moieties per cyclic group.

17. The composition as defined in claim 1, wherein the second material comprises one or more organic monomer, organic oligomer, or organic polymer.

18. The composition as defined in claim 1, wherein the second material comprises one or more inorganic material.

19. The composition as defined in claim 18, wherein the inorganic material comprises one or more of inorganic monomer, inorganic oligomer, or inorganic polymer.

20. The composition as defined in claim 19, wherein the inorganic polymer comprises one or both of a carboxylic-acid terminated oligo(dimethylsiloxane) or a poly(dimethylsiloxane).

21. The composition as defined in claim 18, wherein the inorganic material comprises one or more of inorganic salt, organometallic compound, functionalized ceramic particulate, or metal particulate.

22. The composition as defined in claim 1, wherein the second material comprises an inorganic-organic hybrid material.

23. The composition as defined in claim 1, wherein the low-temperature fluidity point material has a fluidity point at a temperature of less than about 50 degrees Celsius.

24. The composition as defined in claim 1, wherein the threshold temperature is in a range of about 25 degrees Celsius to about 100 degrees Celsius.

25. The composition as defined in claim 1, wherein the composition further comprises one or more thermally conductive filler.

26. The composition as defined in claim 25, wherein the filler comprises one or more metals, metal alloys, low-melting temperature alloys, borides, carbides, nitrides, oxides, silicides, graphite, fullerenes, diamond, or carbon nanotubes.

27. The composition as defined in claim 25, wherein the filler comprises one or both of aluminum oxide or boron nitride.

28. The composition as defined in claim 1, wherein the viscosity of the product at a given temperature and shear rate is determined by the concentrations or molar ratio of the first functional group relative to the second functional group.

29. A composition, comprising:
a first oligomeric or polymeric material that has a low-temperature fluidity point and comprises a first functional group; and
a second material that is different from the first material, and the second material comprises a second functional group that is different from the first functional group,
wherein the first functional group and the second functional group are operable to form a reversible chemical bond to increase the viscosity of, or solidify, the composition, and
the first functional group and the second functional group are further operable to disassociate from each in response to input of energy in an amount that is above a threshold energy level, and
with the proviso that the reversible chemical bond is not a covalent bond.

30. The composition as defined in claim 29, wherein disassociation of the first functional group from the second functional group reduces the viscosity of the composition, or fluidizes the composition if the composition is otherwise solid.

31. The composition as defined in claim 29, wherein the input energy is mechanical shear or thermal energy.

32. The composition as defined in claim 29, further comprising a thermally conductive filler.

33. An electronic apparatus, comprising
a heat-generating unit having a surface;
a heat-dissipating unit having a surface; and
the composition as defined in claim 32 disposed on at least one of the heat-dissipating unit surface or the heat-generating unit surface.

34. A rubber article comprising the composition as defined in claim 29.

35. A tire comprising the article as defined in claim 34 wherein the composition is responsive to shear force by reversibly disassociating the first functional group from the second functional group, and re-associating the first functional group with the second functional group subsequent to removal of the shear force, and to thereby increase wet skid resistance.

36. The tire as defined in claim 35, wherein the threshold energy level is a temperature in a range of from about 0 degrees Celsius to about 180 degrees Celsius.

37. A personal care cosmetic, comprising the composition as defined in claim 29.

38. The cosmetic as defined in claim 37, wherein the threshold temperature is about body temperature.

39. The cosmetic as defined in claim 37, wherein the composition is one or more of non-toxic, non-sensitizing, or non-irritating to skin.

40. An adhesive comprising the composition as defined in claim 29.

41. The adhesive as defined in claim 40, wherein the composition is formed as a layer on a substrate surface and is tacky at a temperature in a range above the threshold temperature, and is relatively non-tacky at a temperature in a range below the threshold temperature.

42. A method, comprising:
contacting a product of a first material and a second material with a mating surface of a substrate, the first material having a low-temperature fluidity point comprising a first functional group; and the second material comprising a second functional group, wherein the first functional group can interact with the second functional group below a threshold temperature to form a product having a viscosity greater than the viscosity of the first material or of the second material;
heating the product to a temperature in a range that is greater than the threshold temperature;
cooling the product to a temperature below the threshold temperature to adhere to the surface; and optionally
reheating the product to a temperature above the threshold temperature so as to detach the product from the mating surface.

43. A method of forming a mold, comprising:
adding a product to an initial mold, the product comprising a first material and a second material, the first material having a low-temperature fluidity point comprising a first functional group; and the second material comprising a second functional group, wherein the first functional group can interact with the second functional group below a threshold temperature such that the product has a viscosity greater than the viscosity of the first material or of the second material;
heating the product to an elevated temperature that is above the threshold temperature;
molding the product at the elevated temperature;
cooling the product to a working temperature that is below the threshold temperature;
releasing the product from the initial mold to form a re-workable mold formed from the product; and
adding raw material to the re-workable mold, wherein the raw material has a fluidity point that is in a temperature range that is lower than the threshold temperature, and the working temperature of the mold is in a range that is greater than the fluidity point of the raw material, and is lower than the threshold temperature of the product.

44. A method, comprising:
contacting a first material to a second material, wherein the first material has a low-temperature fluidity point and comprises a first functional group, and the second material is different from the first material and comprises a second functional group that is different from the first functional group, and the contacting is such that the first functional group and the second functional group form a reversible chemical bond below an energy threshold level resulting in a solid or high-viscosity composition, with the proviso that the reversible chemical bond is not a covalent bond; and optionally
disassociating the first functional group from the second functional group by inputting energy at an energy input level above the energy threshold level to fluidize or lower the viscosity of the composition.

45. The method as defined in claim 44, wherein the energy is thermal energy.

46. The method as defined in claim 44, wherein the energy is mechanical energy.

47. The method as defined in claim 44, further comprising contacting the composition to a surface of a heat-dissipating unit.

48. The method as defined in claim 44, further comprising contacting the composition to a surface of a heat-generating unit.

49. The method as defined in claim 44, further comprising contacting the composition to a chip, to a substrate, or to both a chip and a substrate, wherein the substrate comprises an electronic board unit.
